(19) United States
(12) Patent Application Publication
(10) Pub. No.: US 2004/0082352 A1
(43) Pub. Date: Apr. 29, 2004

(54) Enhanced group call implementation

(75) Inventors: Edward J. Keating, Deer Park, IL (US); James Kovac, Streamwood, IL (US); Donivon Hettich, Mundelein, IL (US)

Correspondence Address: POSZ & BETHARDS, PLC, 11250 ROGER BACON DRIVE, SUITE 10, RESTON, VA, 20190, US

(73) Assignee: MOTOROLA INC.

(21) Appl. No.: 10/282,516

(22) Filed: Oct. 29, 2002

(51) Int. Cl. H04B 7/00; H04Q 7/20

(52) U.S. Cl. 455/519; 455/518

(57) ABSTRACT

A method, equipment, and environment for dynamically controlling a wireless group call and group call participants in a manner that provides and enables accurate billing of each call participant. The methodology involves selecting a group of mobile stations to participate in the wireless group call (30) and causing an invitation message to be transmitted to the group of mobile stations (34). The methodology then includes setting up a dynamic group of mobile stations based on replies received from the group of mobile stations (36), preferably by editing the dynamic group of mobile stations, and then validating the mobile stations in the dynamic group as members of the wireless group call (38).

### FIELD OF THE INVENTION

The present invention relates to wireless communications, and specifically to wireless communications with enhanced group call implementation among wireless groups.

### BACKGROUND OF THE INVENTION

Current wireless technology enables a wireless conference, or group, call to be conducted on bands below cellular communications bands, such as bands at or below 850 MHz. Such a feature enables subscribers to communicate in a two-way radio mode without the need for conventional wireless communication set-up. In addition, a wireless group call enables all mobile stations within the same cell to share channel resources, as opposed to a conventional land-line group call that would consume an individual traffic channel and would require a separate full duplex conference bridge port for each participant.

In such a conventional wireless or landline group call, all participating mobile stations are connected to what is known as a conference bridge. All connections to the conference bridge are full duplex until they reach the conference bridge, at which time a conference bridge controller combines input paths to all of the output paths so that all call participants can hear one another.

In addition, a conventional wireless group call is restricted to a static predetermined group of participants, thereby inhibiting any dynamic group membership. Even if such a sub-group is set up ahead of time, it is impossible to determine who has been invited, who is actually participating in the call and for what duration. Consequently the complexity of an associated group call billing algorithm is increased with respect to identifying which participants to bill.

Therefore, what is needed is a method, equipment, and environment for dynamically controlling a wireless group call in a manner that provides dynamic group membership and accurate billing information.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a diagram of an exemplary wireless dispatch communication environment that is capable of supporting a wireless conference or group call with dynamic membership;

FIG. 2 is a flow diagram of the methodology used for set-up of a group call in the wireless dispatch communication environment of FIG. 1;

FIG. 3 is a front elevation view of a leader mobile station used for wireless group call set-up and control; and

FIG. 4 is a flow diagram of the methodology used for arbitration of a group call in the wireless dispatch communication environment of FIG. 1.

### DETAILED DESCRIPTION OF THE PRESENTLY PREFERRED EXEMPLARY EMBODIMENTS

In overview form the present disclosure concerns systems, methods, and equipment or apparatus that provide communications services to users of such systems and equipment and specifically techniques for implementing an enhanced group call capability with dynamic membership and accurate billing information, preferably, in a dispatch environment. More particularly various inventive concepts and principles embodied in system controllers or user devices and methods therein for establishing a group call with dynamic membership chosen in part by the coordinator or leader of the call and in part by the potential participants in such a call all for the convenience and advantage of users or consumers of such dispatch services and group calls are discussed and described. The dispatch systems, equipment, and the like may be found in systems such as integrated Digital Enhanced Networks (iDEN™) or more conventional dispatch networks such as those providing services to various public safety organizations as well as other public access systems that offer dispatch like group calls.

As further discussed below various inventive principles and combinations thereof are advantageously employed to limit transmissions resulting from the lack of consideration by a user or equipment failure, thus alleviating various problems associated with known systems that ignore the problem or rely on a fixed inflexible approach, thereby advantageously facilitating a fair and reasonable approach to controlling duration of transmission from users, provided these principles or equivalents thereof are utilized.

The instant disclosure is provided to further explain in an enabling fashion the best modes of making and using various embodiments in accordance with the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions. Much of the inventive functionality and many of the inventive principles are best implemented with or in software programs and instructions. It is expected that one of ordinary skill, notwithstanding possibly significant effort and many design choices motivated by, for example, available time, current technology, and economic considerations, when guided by the concepts and principles disclosed herein will be readily capable of generating such software instructions with minimal experimentation. Therefore, in the interest of brevity and minimization of any risk of obscuring the principles and concepts according to the present invention, further discussion of such software, if any, will be limited to the essentials with respect to the principles and concepts used by the preferred embodiments.

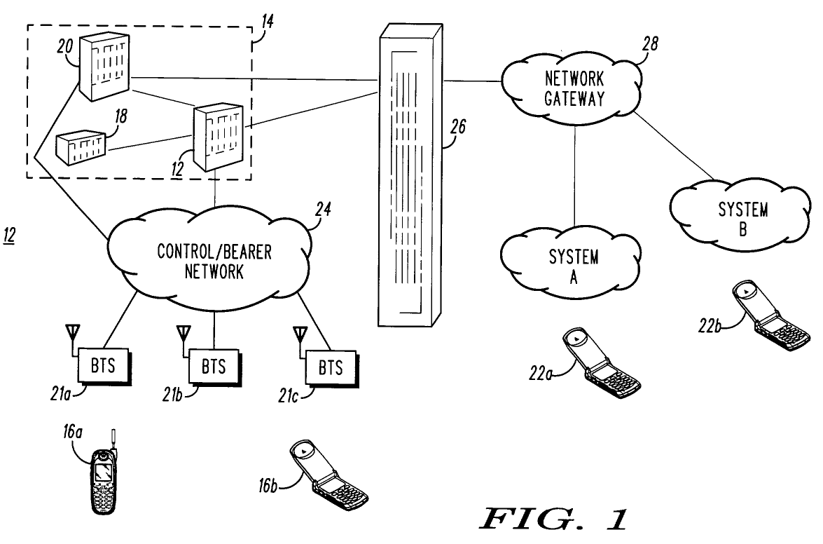

Referring now to the drawings in which like numerals reference like parts, FIG. 1 shows an exemplary wireless dispatch communication environment 10 that is capable of supporting a wireless conference or group call (hereinafter referred to generally as a group call). The wireless dispatch communication environment 10 may be of the type that supports, for example, a 25 KHz time division multiplex access system over which group calls can be conducted on bands below cellular communications bands, such as bands at or below 850 MHz, and which is often referred to as a cellular system with dispatch capabilities. One such exemplary system is an integrated Dispatch Enhanced Network, known commercially as iDEN™, available from Motorola Corporation. However, the system may be any wireless system such as QCHAT™, available from QUALCOMM, DirectConnect™, available from NEXTEL, or any cellular, specialized mobile radio (SMR) or enhanced specialized mobile radio (ESMR) that supports group calls in a manner that will be described below in detail.

The wireless dispatch communication environment 10 includes one or more dispatch application processors (DAPs), such as the DAP 12, which is preferably a fault tolerant redundant multi-processor based computer platform, such as, for example, a Compaq Tandem computer platform on which dispatch application software is integrated. The DAP 12 functions to track the status of mobile stations, such as the mobile stations 16a, 16b, that are enabled with technology, such as the above-mentioned iDEN™ or QCHAT™ technology, and that are thus capable of participating in a group call. Although referred to herein as mobile stations it is clear that the mobile stations may be a handsets or any other device, such as a personal digital assistant that is properly equipped to interface and interact with the particular system that is providing services to the device. More specifically, for reasons discussed below in detail, the DAP 12 controls dispatch operations to mobile stations, such as the mobile stations 16a, 16b for both group and private calls, as well as the conflict and session control of packetized wireless data.

The DAP 12 is located within an area dispatch processor switching office (DPSO) 14 for an urban area, which is a geographic area covered by many cell sites that provide RF coverage for private or group calls and/or data communications such as wireless Internet access. Typically, up to 15 DAPs may be implemented in the DPSO 14 to serve each cell site in an urban area, with each of the DAPs being in communication with other DAPs serving the same cell sites within the urban area. However, the number of DAPs and cell sites will vary depending upon call volume and other subscriber parameters associated with a particular urban area. For purposes of discussion and ease of illustration, only the one DAP 12 is shown.

The wireless dispatch communication environment 10 also includes a billing accumulator 18, which is realized through software run either on the DAP 12 or on a physically separate processor located in the DPSO 14. The billing accumulator 18 collects information pertaining to group calls, such as, for example, the call originator, the number of cell sites involved in the call, the potential number of participants and call duration, and preferably also actual call participants and the length of time spent by each of the participants on the call. The billing accumulator 18 then forwards the collected information to a billing system (not shown) managed and maintained by a service provider (not shown).

In addition, the wireless dispatch communication environment 10 also includes a wireless data controller 20 that is physically separate from the DAP 12. The wireless data controller 20 has a hardware platform that is similar to the DAP 12 in that it is preferably a redundant multi-processor based controller. The wireless data controller 20 acts as a mobile station gateway by controlling a mobile station data session or, in other words, acting as the mobile IP foreign agent for a mobile station during a data communications session. More specifically, the wireless data controller 20 tracks data that is transmitted between, for example, an Internet host and a particular mobile station to therefore track the state of operation of the particular mobile station. Typically, a number of wireless data controllers are implemented within an urban area either internally within a Dispatch Processor Switching Office (DPSO) behind a firewall or externally with connectivity to the Internet. However, the actual number of wireless data controllers will vary depending upon the number of subscribers, the data volume and other subscriber parameters associated with a particular urban area. For purposes of discussion and ease of illustration, only the one wireless data controller 20 is shown.

In the wireless dispatch communication environment 10, the mobile stations 16a, 16b are capable of communicating with other mobile stations, such as exemplary mobile stations 22a, 22b, that are members of other cellular systems with dispatch capabilities, such as code division multiple access (CDMA), GSM, trunking (2-way radios) or other iDEN™ systems and that are identified generally as exemplary systems A and B. The mobile stations 16a, 16b communicate with the mobile stations 22a, 22b across communications links established through conventional base transceiver stations (BTSs) 21a, 21b, 21c. The BTSs 21a-21c in turn communicate with the DAP 12 through a link established through a control/bearer network 24, which is preferably a mesh network such as an asynchronous transfer mode (ATM) switch that handles all control aspects of communications between the DAP 12 and the BTSs 21a-21c as well as packetized data transmission between the wireless data controller 20, and the BTSs 21a-21c. Alternatively, the DAP 12 may communicate directly with the BTSs 21a-21c through an Internet Protocol (IP) mesh established through proxy servers (not shown).

The control bearer network 24 also handles all control aspects of packetized data transmission from the BTSs 21a-21c and the mobile stations 22a, 22b through a gateway 26, which is a conventional public switched telephone network (PSTN) or Internet connection to other similar or different physical systems such as the exemplary systems A and B. More specifically, the gateway 26 is connected to the systems A and B through a network gateway 28, which is typically an IP or, in the case of a CDMA system, a session initiation protocol (SIP), H.323, or Skinny gateway realized by a set of routers (not shown) for group calls involving other mobile stations such as the mobile stations 22a, 22b.

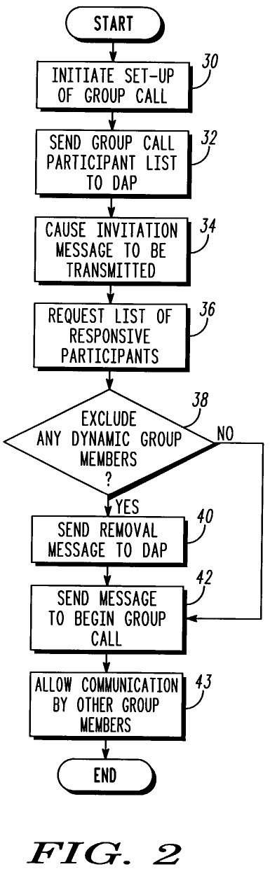

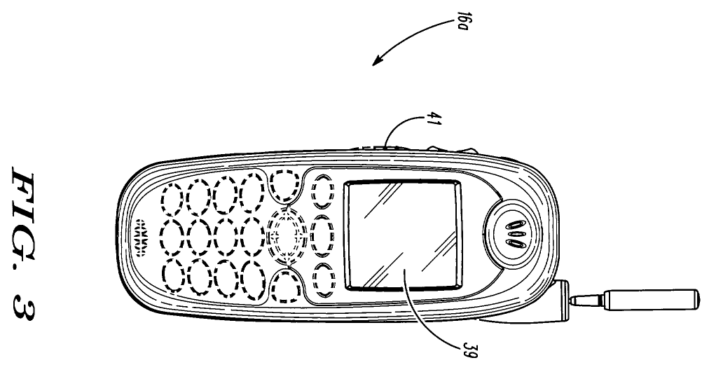

Referring to FIGS. 1-3, set-up of a group call in the wireless dispatch communication environment 10 will now be described. At 30, a group call originator, or leader, initiates set-up of a group call through his or her mobile station by choosing or selecting a group call participant list, which includes mobile stations of all subscribers that the leader wishes to include in the group call. For purposes of the present exemplary discussion, the mobile station 16a, which is shown in more detail in FIG. 3, is defined as the mobile station of the leader. The leader chooses the group call participant list by selecting mobile stations based on one or more of the following: a list of Universal Fleet Member Identifiers (UFMIs), which are codes that respectively identify mobile stations within a geographic area such as an urban area and that are respectively programmed into the mobile stations; phone book entries, such as pre-defined lists of participant phone numbers, stored in the mobile station 16a or on a remote address server (not shown) deployed by a service provider; and mobile stations that have existing group memberships, or, in other words, that are subscribers to the group call feature.

After the leader assembles the group call participant list, at 32 the leader sends the group call participant list from the mobile station 16a to the DAP 12. At 34, by sending the group call participant list to the DAP 12, the mobile station 16a causes the DAP 12 to transmit an invitation message to all mobile stations on the group call participant list. The invitation message is sent via the wireless data controller 20 to each mobile station on the group call participant list such as, for example, the mobile stations 16b, 22a, 22b.

The message may include the group call participant list to provide a meeting context for invited participants who may join the group call, as well as a dynamic talk group identifier (group ID) generated by the DAP 12 for use during the group call, either of which may be displayed on the mobile station displays (not shown). The group call participant list and/or the dynamic group ID may alternatively be sent during a subsequent transmission, such as a message to begin the group call, of the DAP 12 to the mobile stations on the group call participant list. Regardless, each of the mobile stations on the group call participant list retains the dynamic group ID, once received, and subsequently monitors control channels for wireless group call leader pages and wireless group call control messages containing that dynamic group ID. The DAP 12 may be programmed to encrypt the group call participant list and/or the group ID number depending on the level of security desired by the leader for the group call.

At 36, the leader sends a message to the wireless data controller 20 requesting a list of participants that have responded and that want to participate in the group call, hereinafter referred to as the dynamic group. The wireless data controller 20 in turn requests the dynamic group ID from the DAP 12. The DAP 12 queries the wireless data controller 20 as to whether a response or responses to the invitation message has or have been received in order to compile the dynamic group of mobile stations. If a NO response is received from a mobile station, that mobile station is excluded from (e.g. not added to) the dynamic group. If a YES response is received from a mobile station, that mobile station is added to the dynamic group by, for example, adding that mobile station's UFMI or other mobile station identification data, such as the telephone number for a CDMA mobile station, or any other identification numbers used by other systems, to the dynamic group. If a response is not received from a mobile station, that mobile station's UFMI is not added to the dynamic group; however, the non-responsive mobile station also is not disqualified from later joining the dynamic group at any time up to and including while the group call is active or being conducted. Rather, an ALERT message is queued in the mobile station for later retrieval if, for example, the mobile station is not powered on when the DAP 12 sends the invitation message in response to the leader sending the group call participant list at 32 to the DAP 12.

Once the DAP 12 determines the dynamic group and the wireless data controller 20 sends the dynamic group to the mobile station 16a, at 38 the dynamic group is displayed in list form on the display 39 of the mobile station 16a to enable the leader to review the dynamic group to determine if any erroneously included mobile stations, such as, for example, mobile stations of former employees no longer with a particular company, should be excluded. If the leader determines that a particular mobile station or stations should be removed from the dynamic group list, at 40 the leader sends a message through the mobile station 16a to the DAP 12 instructing the DAP 12 to remove the particular mobile station or stations from the dynamic group, and alternatively instructing the DAP 12 to send an uninvite message to the particular mobile station or stations. If the dynamic group ID has been sent or transmitted this will remove the dynamic group ID from all now uninvited stations.

Subsequent to the leader removing erroneously included mobile stations from the dynamic group, at 42 the leader sends a message from the mobile station 16a to the DAP 12 to begin the group call and to establish a half-duplex connection in existing iDEN™ technology through the wireless data controller 20. The DAP 12 then pages each of the mobile stations included in the dynamic group to inform the mobile stations that the group call is set to begin. The DAP 12 then receives an explicit page response from each of the participating mobile stations included in the dynamic group that provides the DAP 12 with specific mobile station information thus verifying membership in the dynamic group as well as geographical location information in a form, such as the mobile station cell location. This information including geographical location information enables the DAP 12 to not only validate the mobile stations as members of the dynamic group but also allows for proper scheduling or resources to support the group call and enables the billing accumulator 18 to generate billing records for each of the participating mobile stations once the group call is terminated based on validation of the mobile stations by the DAP 12. Once the DAP 12 receives the first page response from a first mobile station, the leader can begin communicating with the first mobile station and then with other dynamic group member's responsive mobile stations as they respond by, for example, keying a push-to-talk button 41 on the mobile station 16a assuming for purposes of discussion that the mobile station 16a is enabled with iDEN™ technology. All participating mobile stations located within a common cell can also share channel resources using, for example, conventional iDEN™ technology, as opposed to a wireless or wireline interconnect conference that would consume individual traffic channels and circuits for each participant and that would also require a separate conference bridge.

Also, by identifying each of the mobile stations in the dynamic group, the DAP 12, and therefore the leader, can dynamically track the mobile stations and can provide an updated dynamic group list to the mobile station 16a as well as all other mobile stations in the dynamic group for display on the mobile station displays, with it being understood that each mobile station has a display similar to the display 39 of the mobile station 16a. Such a feature not only enables all participants to be continually apprised of who is currently participating in the group call, but it also enables the billing accumulator 18 to generate accurate billing information for each of the mobile stations.

Rather than sending a message at 42 from the mobile station 16a to the DAP 12 to begin the group call, the leader may alternatively send a message to the DAP 12 instructing the DAP 12 to transmit a wireless group call alert list to all of the mobile stations in the dynamic group of mobile stations. In response, the DAP 12, and ultimately the mobile station 16a, would then receive private mobile station identification data, such as individual mobile station identification numbers, of each of the mobile stations in the dynamic group of mobile stations informing mobile stations in the dynamic group of the identify of all participants in the wireless group call.

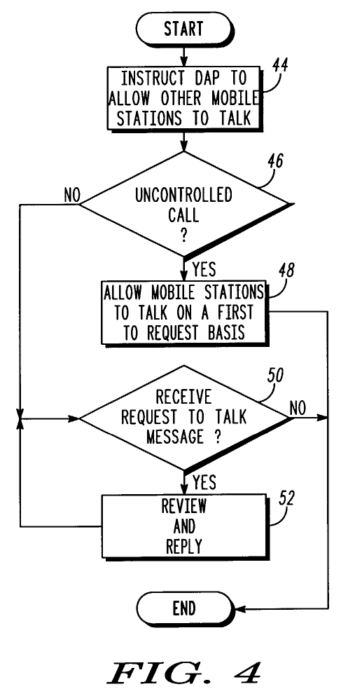

Further, any of the mobile stations in the dynamic group that are participating in the group call may suspend participation in the group call to perform some other alternate wireless communication function such as, for example, answering an incoming wireless call or page, or accessing wireless data, such as email, over a wireless Internet connection or any other distraction. Once the alternate wireless communication has been completed, the mobile station may then re-join the group call or drop the group call altogether. If a mobile station drops the group call, the dynamic group identification number stored therein is erased from the mobile to inhibit further recognition of the wireless group call and related messaging based on the dynamic group identification number, and the billing accumulator 18 subsequently generates appropriate billing information for mobile station. Because the DAP 12 validates each of the mobile stations in the dynamic group as described above, the billing accumulator 18 is able to generate accurate billing information even if, for example, a mobile station temporarily suspends participation in or altogether drops the group call. Therefore, the billing of each mobile station participant more accurately reflects specific time spent by the mobile station participating in the group call than in conventional wireless group call technology, in which statically predetermined group call members are billed regardless of whether and for how long the members actually participated in the group call. In any event at 43 other members of the dynamic group are allowed to talk on a controlled or uncontrolled basis, which will be discussed in further detail below with specific reference to FIG. 4.

Referring now to FIGS. 1-4, arbitration by the leader at the mobile station 16a of the above initiated group call will now be discussed. At 44, when the leader ends the initial group call discussion by de-keying the push-to-talk button 41 on the mobile station 16a, the mobile station 16a sends a message to the DAP 12 instructing the DAP 12 to allow other mobile stations in the dynamic group to talk using existing group call functionality, such as iDEN™ group call functionality. If at 46 the leader programs the group call settings at the beginning of the call of the mobile station 16a so that the group call is an uncontrolled group call, at 48 the leader will send or cause to be sent a talk grant from the mobile station 16a to, preferably, the first subsequent user or alternatively a selected plurality of subsequent users to hit or activate the push-to-talk button, (similar to the push-to-talk button 41 on the mobile station 16a) on his or her mobile station.

However, if at 46 the leader programs the group call settings at the beginning of the call so that the group call is a controlled group call, at 50 the mobile station 16a determines if any request to talk messages have been sent from dynamic group member mobile stations to the DAP 12 and then forwarded by the DAP 12 to the mobile station 16a. Typically, these request to talk messages or version thereof will show on the display 39 of the mobile station 16a. If so, at 52 the leader will then review the respective request to talk messages and will respectively reply with either a talk grant or a talk deny (typically absence of talk grant) message. If a requesting mobile station receives a talk deny, typically does not receive a talk grant, message, the mobile station will not be allowed access to system resources or channels to enable the subscriber at that mobile station to talk. If a requesting mobile station receives a talk grant message, the mobile station will be allowed access to such system resources to enable the subscriber at that mobile station to talk until he or she releases the push-to-talk button on the mobile station, at which time the mobile station 16a will again determine if the DAP 12 has forwarded one or more additional request to talk messages.

Once it is determined at 48 or 50 that no additional request to talk messages have been received for a predetermined time such as, in the case of iDEN™ technology, the expiration of a hang timer or the lack of a mobile transmission for a predetermined amount of time, the DAP 12 terminates the group call by sending a call termination message to each BTS involved in the call. Each BTS then transmits a call stop message to the mobile stations communicating there through, and the mobile stations remove their respective dynamic group identifiers assigned during call set-up. Each BTS then sends call termination data such as mobile identity and cell location, to the billing accumulator 18 through the DAP 12, and the billing accumulator 18 generates billing data, including time spent on the group call, for each of its local member mobile stations involved in the group call.

While implicit in the above discussion it should be noted that the mobile stations 16a, 16b, 22a, and 22b each include an antenna coupled to a transceiver or receiver and transmitter that are each further inter coupled to and controlled by a processor based controller with associated memory. The controller is further coupled to a user interface comprising a display, keyboard, and possibly various other user controls, such as a PTT button, as well as audio transducers including a microphone and speaker or earpiece. The specificities of each of these elements are generally known and will depend on the particular system within which the mobile station operates. The associated memory will include software routines that when executed by the processor will result in the controller controlling the transceiver, display and responding to the keyboard or individual keys in such a fashion as to execute the methods above discussed at the mobile station, provided the principles and concepts disclosed herein are employed.

In view of the foregoing, it should be appreciated that the wireless dispatch communication environment 10 is capable of supporting a wireless group call in which the call leader controls the call from his or her mobile station and in which the group of mobile station participants can be dynamically changed during or as part of the call setup or even during the call. In addition, the wireless dispatch communication environment 10 facilitates group calls in which call participants can temporarily suspend their participation to perform an alternate wireless communication function or other task, such as respond to another wireless call or perhaps some other interruption, or permanently drop from participation in the call, wherein the call leader can dynamically track call participants, and wherein call participants are accurately billed for time actually spent participating in the group call.

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A method of controlling a wireless group call, comprising:
selecting a group of mobile stations to participate in the wireless group call;
causing an invitation message to be transmitted to the group of mobile stations selected to participate in the wireless group call; and
setting up a dynamic group of mobile stations based on replies received from the group of mobile stations selected to participate in the wireless group call in response to the causing an invitation message to be transmitted to the group of mobile stations selected to participate in the wireless group call.

2. The method of claim 1, wherein the setting up of a dynamic group of mobile stations based on replies received from the group of mobile stations selected to participate in the wireless group call in response to the causing an invitation message to be transmitted to the group of mobile stations selected to participate in the wireless group call further comprises:
reviewing a summary list of mobile stations that have responded with positive replies;
specifically selecting only those mobile stations from the summary list of mobile stations that have responded with positive replies that are desired for inclusion in the dynamic group of mobile stations; and
removing undesired mobile stations from the summary list of mobile stations that have responded with positive replies that are not desired for inclusion in the dynamic group of mobile stations.

3. The method of claim 1, further including causing verification of respective locations of mobile stations in the dynamic group of mobile stations to determine billing information for the mobile stations in the dynamic group of mobile stations to wherein accurate billing of the mobile stations in the dynamic group of mobile stations is enabled.

4. The method of claim 1, further comprising causing dynamic group identification data to be transmitted to the dynamic group of mobile stations to enable the mobile stations in the dynamic group of mobile stations to participate in the wireless group call.

5. The method of claim 3, further comprising causing a page to be sent to each of the mobile stations in the dynamic group of mobile stations to validate the mobile stations in the dynamic group of mobile stations prior to enabling the mobile stations to participate in the wireless group call.

6. The method of claim 1, further comprising:
initiating the wireless group call;
causing a list of mobile stations in the dynamic group of mobile stations to be transmitted to each of the mobile stations in the dynamic group of mobile stations; and
subsequently enabling the mobile stations in the dynamic group of mobile stations to participate in the wireless group call.

7. The method of claim 6, wherein the subsequently enabling the mobile stations in the dynamic group of mobile stations to participate in the wireless group call comprises subsequently enabling the mobile stations in the dynamic group of mobile stations to participate in the wireless group call in a controlled manner.

8. The method of claim 7, wherein the subsequently enabling the mobile stations in the dynamic group of mobile stations to participate in the wireless group call in a controlled manner comprises selecting from one or more of the mobile stations in the dynamic group of mobile stations transmitting a request to talk.

9. The method of claim 6, wherein the subsequently enabling of the mobile stations in the dynamic group of mobile stations to participate in the wireless group call comprises subsequently enabling the mobile stations in the dynamic group of mobile stations to participate in the wireless group call in an uncontrolled manner.

10. The method of claim 9, wherein the subsequently enabling the mobile stations in the dynamic group of mobile stations to participate in the wireless group call in an uncontrolled manner comprises enabling the mobile stations in the dynamic group of mobile stations to talk based on an order in which respective mobile station talk requests are received.

11. The method of claim 1, wherein the setting up a dynamic group of mobile stations based on replies received from the group of mobile stations selected to participate in the wireless group call in response to the causing an invitation message to be transmitted to the group of mobile stations selected to participate in the wireless group call comprises:
causing a wireless group call alert list of the dynamic group of mobile stations to be transmitted to all of the mobile stations in the dynamic group of mobile stations; and
receiving private mobile station identification data from each of the mobile stations in the dynamic group of mobile stations to confirm participation in the wireless group call.

12. A method of selectively participating in a wireless group call, comprising:
receiving an invitation message to participate in the wireless group call;
responding to the invitation message;
if the responding to the invitation message comprises transmitting an acceptance message to indicate a desire to participate in the wireless group call, receiving a group call leader page to thereby validate membership status in the wireless group call; and
receiving and displaying a dynamic list of all members of the wireless group call upon initiation of the wireless group call.

13. The method of claim 12, wherein the receiving of an invitation message to participate in the wireless group call comprises receiving an invitation message, including one of a list of invited participants and a dynamic group identification number, to participate in the wireless group call.

14. The method of claim 13, further comprising retaining the dynamic group identification number and monitoring control channels for wireless group call leader pages and wireless group call control messages.

15. The method of claim 12, further comprising dropping the wireless group call, thereby causing erasure of the dynamic group identification number to inhibit further recognition of the wireless group call and related messaging based on the dynamic group identification number.

16. The method of claim 12, wherein if the responding to the invitation message comprises transmitting an acceptance message to indicate a desire to participate in the wireless group call, further transmitting mobile station identification data to establish membership in a wireless group call dynamic group of mobile stations.

17. The method of claim 12, wherein if the responding to the invitation message comprises transmitting an unauthorized acceptance message, subsequently receiving an uninvite message for inhibiting participation in the wireless group call.

18. The method of claim 12, further comprising participating in the wireless group call upon the initiation of the wireless group call in one of a controlled and an uncontrolled manner.

19. The method of claim 12, further comprising temporarily suspending participation in the wireless group call to perform another function; and
re-joining the wireless group call at a later time.

20. A method of brokering a wireless group call, comprising:
transmitting an invitation message to mobile stations selected to participate in the wireless group call based on received invitation transmit instructions;
receiving acceptance messages from mobile stations within the group of mobile stations selected to participate in the wireless group call that wish to participate in the wireless group call;
transmitting a group call leader page to validate membership status in the wireless group call of the mobile stations within the group of mobile stations selected to participate in the wireless group call that wish to participate in the wireless group call; and
receiving mobile station information from the mobile stations within the group of mobile stations selected to participate in the wireless group call that wish to participate in the wireless group call and that have a validated membership status.

21. The method of claim 20, further comprising:
initiating the wireless group call by transmitting a wireless group call alert list of the dynamic group of mobile stations to all of the members of the dynamic group of mobile stations; and
receiving private mobile station identification data from each of the mobile stations in the dynamic group of mobile stations to confirm participation in the wireless group call.

22. The method of claim 20, further comprising:
initiating the wireless group call;
subsequently receiving call termination data from a mobile station of the dynamic group of mobile stations when the mobile station drops the wireless group call or upon completion of the wireless group call; and
causing billing data to be generated for the mobile station of the dynamic group of mobile stations based on the receiving of call termination data from the mobile station of the dynamic group of mobile stations, the billing data based in part on location information for the mobile station.

23. A wireless dispatch communication environment comprising:
at least one dispatch application processor (DAP) for communicating with mobile stations selected to participate in a wireless group call to validate membership in a dynamic group of mobile stations based on information received from the mobile stations;
a wireless data controller in communication with the DAP for tracking data sent to and from each of the mobile stations in the dynamic group of mobile stations through the DAP; and
a billing accumulator in communication with the DAP for generating billing information for each of the mobile stations in the dynamic group of mobile stations based at least in part on mobile station location information received by the DAP from the wireless data controller.

24. The wireless dispatch communication environment of claim 23, wherein:
the at least one dispatch application processor (DAP) is for communicating with the mobile stations selected to participate in the wireless group call by
transmitting an invitation message to, and for display on, the mobile stations selected to participate in the wireless group call based on invitation transmit instructions received from a mobile station of a wireless group call leader; and
receiving acceptance messages from the mobile stations selected to participate in the wireless group call that wish to participate in the wireless group call.

25. The wireless dispatch communication environment of claim 24, wherein:
the at least one dispatch application processor (DAP) is for communicating with the mobile stations selected to participate in the wireless group call by
transmitting a group call leader page, based on received paging instructions from the mobile station of the wireless group call leader, to determine mobile station location information and to validate membership status in the wireless group call for the mobile stations selected to participate in the wireless group call that wish to participate in the wireless group call; and
receiving the mobile station location information from the wireless data controller for the group of mobile stations selected to participate in the wireless group call that wish to participate in the wireless group call and that have a validated membership status.
